(19) United States
(12) Patent Application Publication
(10) Pub. No.: US 2010/0156182 A1
(43) Pub. Date: Jun. 24, 2010

(54) GARAGE DOOR OPENER WITH SECONDARY POWER SOURCE

(76) Inventors: Brian Dale Mertel, Simpsonville, SC (US); Ernest Chandler Bostic, Easley, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/426,356

(22) Filed: Apr. 20, 2009

Related U.S. Application Data
(60) Provisional application No. 61/139,362, filed on Dec. 19, 2008.

(51) Int. Cl. H02J 9/06

(52) U.S. Cl. 307/66

(57) ABSTRACT

A garage door opener having a secondary power source. The garage door opener includes a drive unit and an opening mechanism. The drive unit is configured to be coupled to an external AC power source and to a removable battery pack that provides DC power. The drive unit includes a power unit, a motor coupled to the power unit, and a drive mechanism coupled to the motor. The opening mechanism is coupled to the drive mechanism and configured to open and close a garage door. When AC power is not available, the power unit uses the DC power to operate the garage door opener.

### RELATED APPLICATION

The present patent application claims the benefit of prior filed co-pending U.S. Provisional Patent Application No. 61/139,362, filed on Dec. 19, 2008, the entire contents of which are hereby incorporated by reference.

### BACKGROUND

Garage door openers generally comprise a drive motor which is coupled to the door by means of a screw shaft or chain. The garage door openers include a plurality of inputs and sensors to control operation of the opener. A wired and/or wireless transmitter sends a signal to the opener to open or close the garage door. In addition, sensors detect when the garage door is fully open or fully closed to stop the motor. Other sensors (e.g., mechanical, break beam, etc.) detect objects in the path of the garage door and stop or reverse the motor to prevent injury or damage.

Garage door openers generally operate on 120 VAC power. In the event of a power failure, a garage door opener will not function. When a power failure occurs, a user must release a latch which attaches the garage door to the screw shaft or chain, allowing the user to manually open the garage door.

### SUMMARY

The invention relates to garage door openers with a secondary power source. Specifically, the invention uses removable batteries (e.g., rechargeable battery packs) to power a garage door opener in the event of a power outage.

In one embodiment, the invention provides an electric garage door opener including a drive unit and an opening mechanism. The drive unit is configured to be coupled to an external AC power source and to a removable battery pack that provides DC power. The drive unit includes a power unit, a motor coupled to the power unit, and a drive mechanism coupled to the motor. The opening mechanism is coupled to the drive mechanism and configured to open and close a garage door. When AC power is not available, the power unit uses the DC power to operate the garage door opener.

In another embodiment, the invention provides a method of powering an electric garage door opener including the acts of supplying AC power to a power unit of the garage door opener, supplying DC power from a battery pack removably coupled to the power unit, operating the garage door opener with the AC power, and operating the garage door opener with the DC power when the AC power is not available.

In another embodiment, the invention provides a power system for powering an electric garage door opener. The power system includes a first power cord, a housing, and a socket on the housing. The housing includes a receptacle configured to releasably receive a battery pack and a power unit coupled to the first power cord and the receptacle. The socket is coupled to the power unit and configured to supply AC power to a second power cord coupled to a garage door opener. The power unit receives AC power from the power cord and DC power from the battery pack. The power unit provides the AC power from the power cord to the socket and uses the DC power to generate AC power at the socket when AC power is unavailable from the power cord.

Other aspects of the invention will become apparent by consideration of the detailed description and accompanying drawings.

### BRIEF DESCRIPTION OF THE DRAWINGS

FIG. 1 is a schematic representation of a prior art garage door opener.

FIG. 2 is a block diagram of a prior art garage door opener.

FIG. 3 is a schematic representation of an embodiment of a garage door opener incorporating the invention.

FIG. 4 is a schematic representation of another embodiment of a garage door opener incorporating the invention.

FIG. 5 is a schematic representation of an embodiment of a garage door opener incorporating the invention.

FIG. 6 is a block diagram of a prior art power unit of a garage door opener.

FIG. 7 is a block diagram of an embodiment of a garage door opener.

FIG. 8 is a block diagram of an embodiment of a power unit of the invention.

FIG. 9 is a block diagram of another embodiment of a power unit of the invention.

FIG. 10 is a block diagram of another embodiment of a power unit of the invention.

FIG. 11 is a block diagram of another embodiment of a power unit of the invention.

FIG. 12 is a block diagram of another embodiment of a power unit and a battery station of the invention.

FIG. 13 is a block diagram of another embodiment of a power unit and a battery station of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

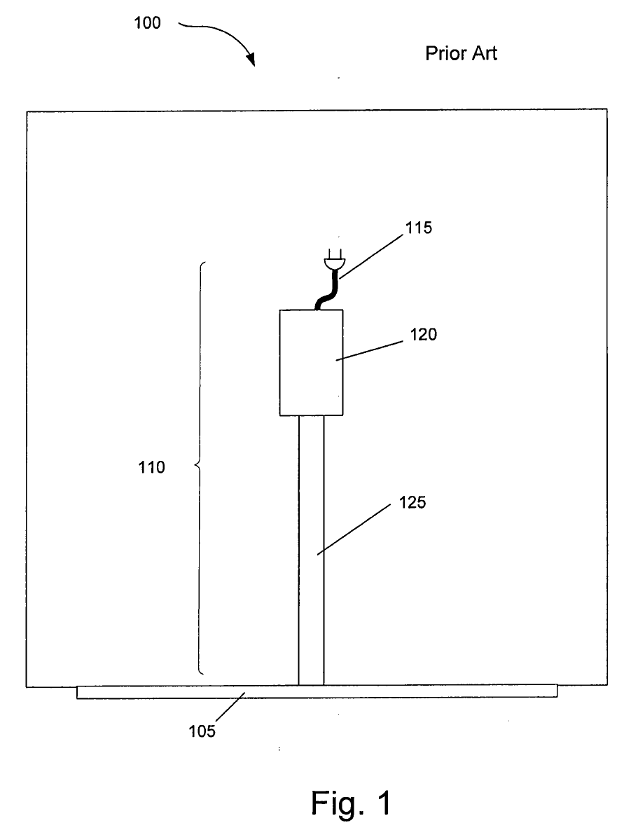

FIG. 1 shows a construction of a garage 100 including a garage door 105 and a prior art garage door opener 110. The garage door opener 110 includes an AC power cord 115, a drive unit 120, and an opening mechanism 125 (e.g., a chain, a screw, etc.). The opening mechanism 125 is coupled to the garage door 105 and to the drive unit 120. Based on inputs received from user controls, safety sensors, and position sensors, a motor in the drive unit 120 is actuated, causing the opening mechanism 125 to open or close the garage door 105.

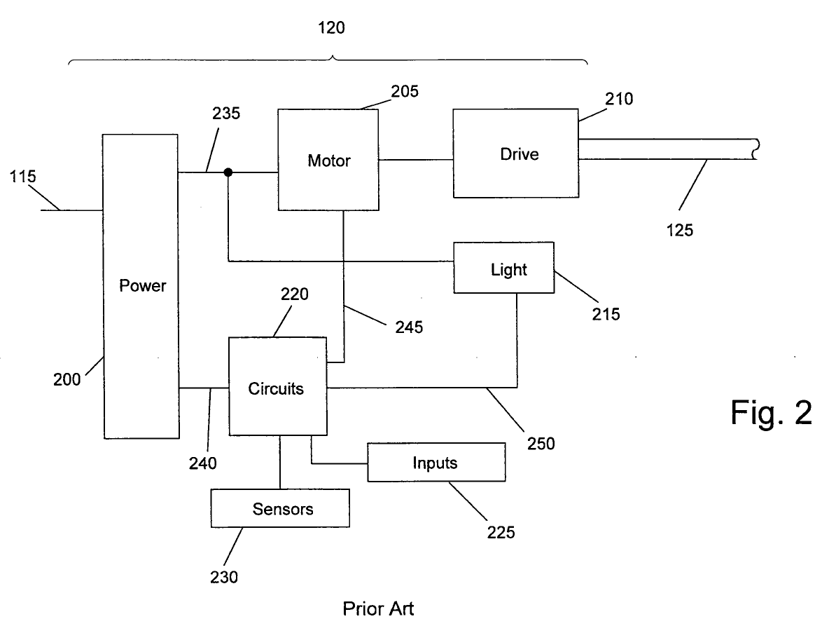

FIG. 2 shows a block diagram of the prior art drive unit 120 of FIG. 1. The drive unit 120 includes a power interface or unit 200, a motor 205, a drive mechanism 210, a light 215, control circuits 220, inputs 225, and sensors 230. The power interface 200 receives AC power (e.g., 120 VAC) from the power cord 115, and provides the AC power to the motor 205 and the light 215 via a power line 235. If the motor 205 is a DC motor, another power line can be provided by the power interface 200 for supplying DC power to the motor. The power interface 200 also converts the AC power to lower voltage DC power, and provides the DC power to the control circuits 220 via a power line 240.

The motor 205 receives power from the power line 235. The control circuits 220 provide control signals to the motor 205 via line 245. Based on the control signals received, the motor 205 rotates its rotor (not shown) in a clockwise rotation or a counter-clockwise rotation, or is stopped. The rotor of motor 205 is coupled to the drive mechanism 210. When the rotor rotates, the drive mechanism 210 links the rotor to the opening mechanism 125, causing the opening mechanism 125 to open or close the garage door 105 depending on the direction of rotation of the rotor. The rotor may rotate in a single direction, and the opening and closing of the garage door may be controlled by gears, etc. in the drive unit 210.

The control circuits 220 also control operation of the light 215, turning the light 215, which receives high voltage AC power via line 235, on or off via line 250. The control circuits 220 also receive signals from the sensors 230 and the inputs 225. The sensors 230 include sensors to detect when the garage door 105 is fully open or fully closed. The sensors also include safety sensors to detect if a person or object is in the path of the garage door 105. The inputs 225 allow a user to direct the garage door opener 110 to open or close the garage door 105. The inputs 225 can be wired, wireless, or both.

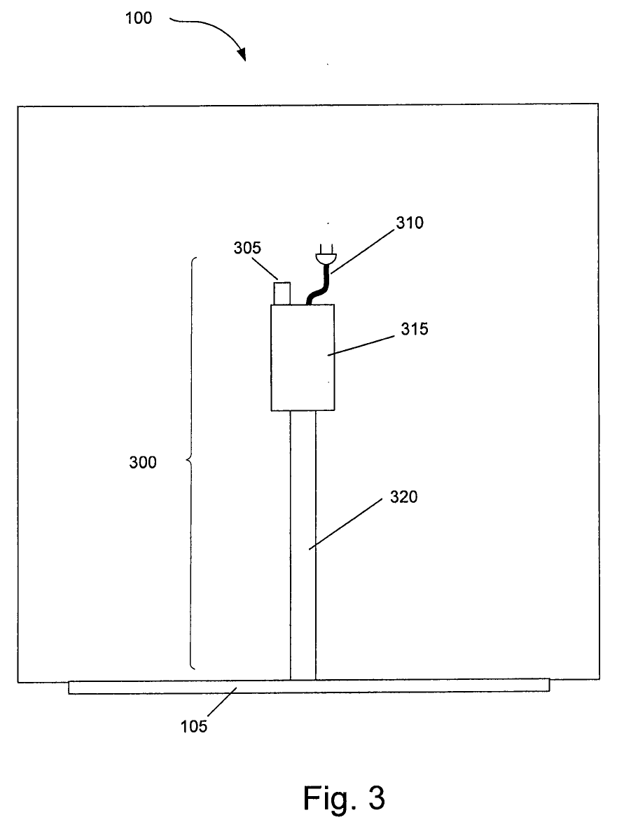

FIG. 3 shows a garage door opener 300 including a removable battery pack 305 as a secondary power source according to an embodiment of the invention. In addition to the battery pack 305, the garage door opener 300 includes an AC power cord 310, a drive unit 315, and an opening mechanism 320 (e.g., a chain, a screw, etc.). The opening mechanism 320 is coupled to a garage door 105 and to the drive unit 315. Based on inputs received from user controls, safety sensors, and position sensors, a motor in the drive unit 315 is actuated, causing the opening mechanism 320 to open or close the garage door 105. The battery pack 305 provides the power necessary to operate the garage door opener 300 when AC power is not provided by the power cord 310 (e.g., during a power outage or when the garage door opener 300 is unplugged, such as when the outlet is used for another device).

In some embodiments, the battery pack 305 is a rechargeable battery pack such as a power tool battery pack. The battery pack 305 can be of different voltages and battery chemistries. A single battery pack 305 or multiple battery packs 305 may be connected in series and/or parallel to provide the voltage and current necessary to operate the garage door opener 300. In the embodiment shown, the drive unit 315 includes one or more receptacles configured to receive the battery pack 305. The receptacles can be configured to accept only certain batteries, and to prevent a battery that is not compatible with the garage door opener 300 from being attached to the garage door opener 300. In some embodiments, faceplate converters can be received by the garage door opener 300 to allow a user to change the receptacle configuration so that different batteries (e.g., different voltages, chemistries, manufacturers) can be used with the garage door opener 300. The battery pack 305 can be continuously mounted on the drive unit 315 or can be added at any time (e.g., when AC power is not available).

In some embodiments, the garage door opener 300 includes a battery charging circuit (not shown). In one embodiment, the battery charging circuit operates as illustrated and described in U.S. Pat. No. 7,508,167 entitled “METHOD AND SYSTEM FOR CHARGING MULTI-CELL LITHIUM-BASED BATTERIES,” issued Aug. 10, 2008, the entire contents of which are hereby incorporated by reference. When AC power is supplied to the garage door opener 300 via the power cord 310, the battery charging circuit provides a current to the battery pack 305 to recharge the battery pack 305, or to maintain the battery pack 305 in a fully charged state. When AC power is absent, the battery pack 305 provides DC power to the garage door opener 300.

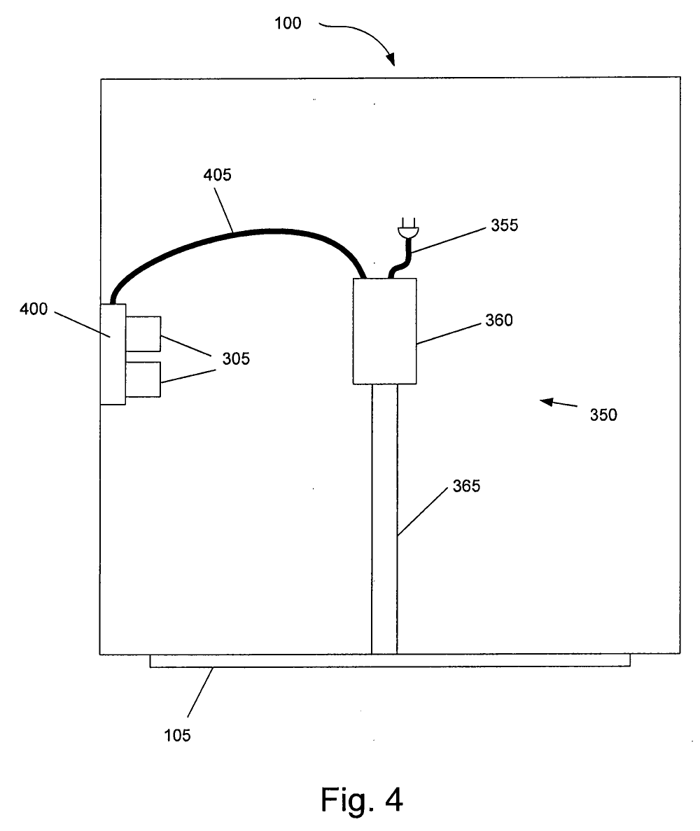

FIG. 4 shows another embodiment of a garage door opener 350 that uses a battery pack 305 as a secondary power source. The garage door opener 350 includes an AC power cord 355, a drive unit 360, and an opening mechanism 365 (e.g., a chain, a screw, etc.). The opening mechanism 365 is coupled to the garage door 105 and to the drive unit 360. Based on inputs received from user controls, safety sensors, and position sensors, a motor in the drive unit 360 is actuated, causing the opening mechanism 365 to open or close the garage door 105. A battery station 400, positioned remotely from the garage door opener 350, is connected to the garage door opener 350 via a cord 405. One or more battery packs 305 can be received in the battery station 400 for providing power to operate the garage door opener 350 when AC power is not supplied via the power cord 355. The battery station 400 can be positioned in an easily accessible place (e.g., in the garage 100 or a house adjacent the garage 100), enabling a user to quickly insert the battery pack 305 when needed, and to not tie up the battery pack 305 when it is not needed to power the garage door opener 350. Therefore, a user can use the battery pack 305 for operating a power tool, and only place the battery pack 305 in the battery station 400 when needed to operate the garage door opener 350. In some embodiments, the battery station 400 includes a battery charging circuit (not shown) for charging the battery pack 305 as described above. Power for the battery charging circuit can be provided from the garage door opener 350 through cord 405, or a separate power cord can be provided with the battery station 400. Thus, a user can charge the battery pack 305, and also have the battery power available for operating the garage door opener 350. The battery station 400 can also be used to store battery packs 305, and maintain the battery packs 305 in a fully charged state. The battery station 400 can also incorporate additional devices which operate using AC power when available, and DC power from the battery packs 305 when AC power is not available. Devices that may be incorporated into the battery station 400 include a radio or other devices as illustrated and described in U.S. patent application Ser. No. 11/745,596 entitled “ELECTRICAL COMPONENT HAVING A SELECTIVELY CONNECTABLE BATTERY CHARGER,” filed May 8, 2007, the entire contents of which are hereby incorporated by reference.

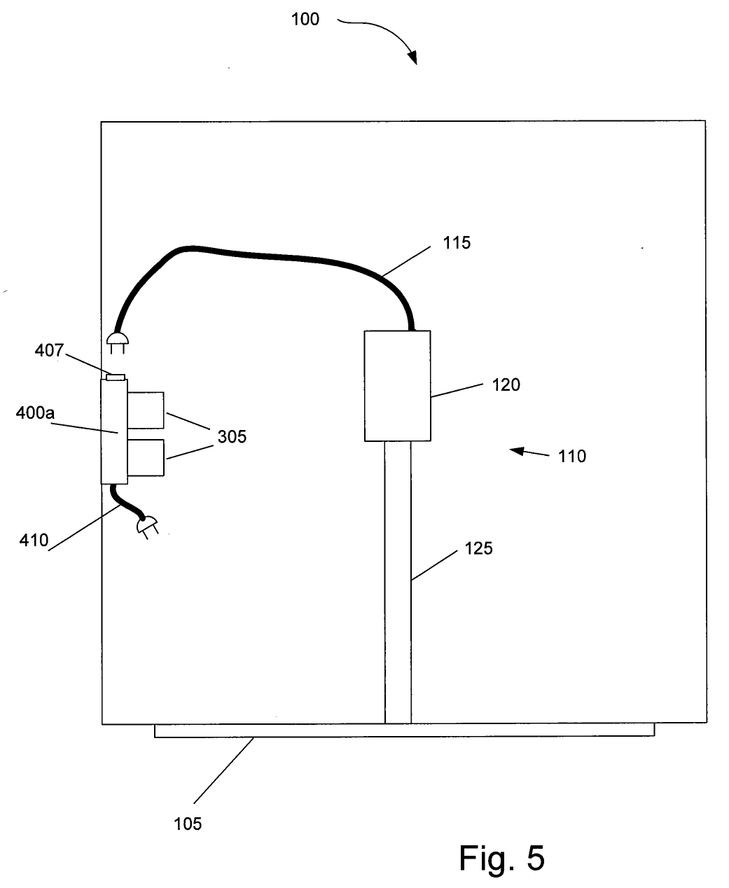

FIG. 5 shows another embodiment of the invention in which a battery pack 305 is used as a secondary power source for the prior art garage door opener 110 of FIG. 1. A battery station 400a, positioned remotely from the garage door opener 110, includes a socket 407 into which the power cord 115 of the garage door opener 110 is plugged. One or more battery packs 305 are received in the battery station 400a for providing power to operate the garage door opener 110 when AC power is not available. The battery station 400a can be positioned in an easily accessible place (e.g., in the garage 100 or in a house adjacent the garage 100), enabling a user to quickly insert the battery pack 305 when needed, and to not tie up the battery pack 305 when not needed. Therefore, a user can use the battery pack 305 for operating another battery powered device such as a power tool, and only place the battery pack 305 in the battery station 400a when needed to operate the garage door opener 110. In some embodiments, the battery station 400a includes a battery charging circuit (not shown) for charging the battery pack 305 as described above. Power for the battery station 400a is provided by power cord 410. When power is available from power cord 410, the battery station 400a provides the AC power received from the power cord 410 to the socket 407, and ultimately the power cord 115. When power is not available from power cord 410 (e.g., during a power outage or when power cord 410 is unplugged), the battery station 400a converts DC power from the one or more battery packs 305 into AC power (e.g., 120 VAC), which is provided to the socket 407 to power the garage door opener 110.

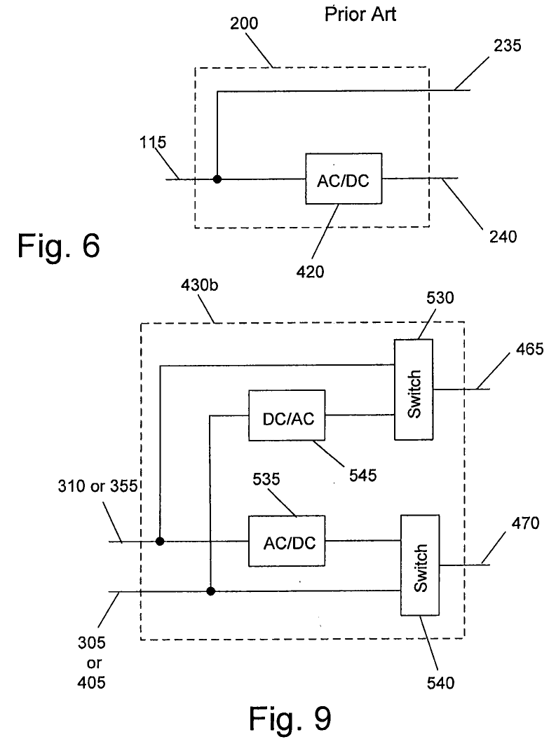

FIG. 6 illustrates a portion of the prior art power unit 200 of FIG. 2. The power unit 200 receives the AC power from the power cord 115 and supplies the AC power to the power line 235. The power unit 200 includes an AC/DC converter 420 which converts the AC power to DC power at a proper voltage for operating the control circuits 220.

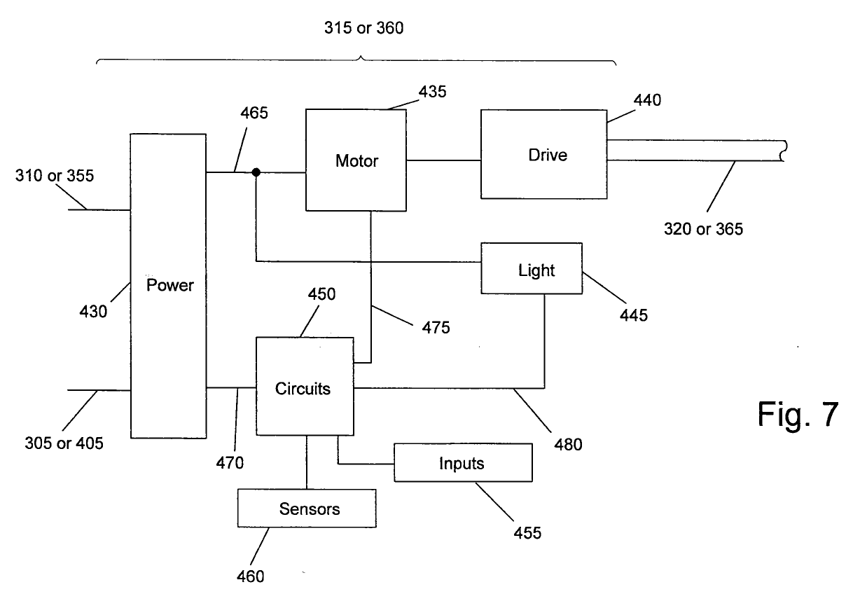

FIG. 7 shows a block diagram of the drive unit 315 of FIG. 3 or the drive unit 360 of FIG. 4. The drive unit 315 or 360 includes a power interface or unit 430, a motor 435, a drive mechanism 440, a light 445, control circuits 450, inputs 455, and sensors 460. The power interface 430 receives AC power (e.g., 120 VAC) from the power cord 310 or 355, and provides the AC power to the motor 435 and the light 445 via a power line 465. If the motor 435 is a DC motor, the power interface 430 converts the AC power to DC power and supplies DC power to the motor 435 via line 465. The power interface 430 also converts the AC power to DC power, and provides the DC power to the control circuits 450 via a power line 470. The power interface 430 also receives DC power from battery packs 305 or via cord 405, and either converts the DC power to AC power, for an AC motor 435, or provides the DC power to a DC motor 435.

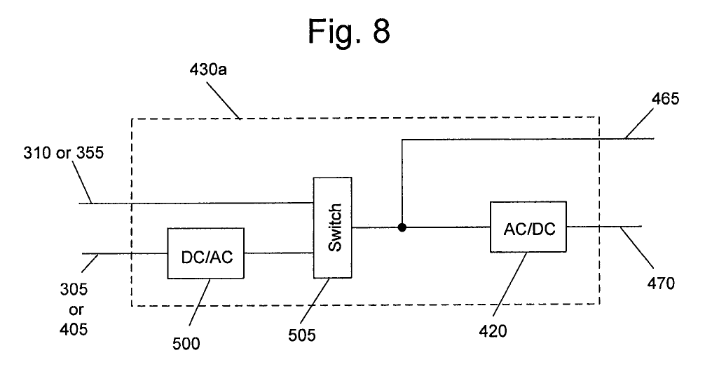

Depending on the type (e.g., AC or DC) and power requirements of the motor 435, the power interface 430 converts the AC and DC power to the proper type and voltage for the motor 435. FIGS. 8-11 illustrate exemplary embodiments of power units that can be incorporated in drive units to convert the AC and/or DC power provided to the drive unit into the proper type and voltage for different motors 435.

FIG. 8 illustrates a power unit 430a that can be incorporated in the drive unit 315 or 360 of FIG. 7, according to an embodiment of the invention. AC power is supplied by the power cord 310 or 355. DC power is supplied by one or more battery packs 305 (FIG. 3) or via cord 405 (from the battery station 400 in FIG. 4). The DC power is supplied to a DC/AC converter 500 which converts the DC power to AC power (e.g., 120 VAC). The AC power from the power cord 310 or 355 and the AC power from the DC/AC converter 500 are both supplied to a switch 505. The power unit 430a determines if power is being supplied by the power cord 310 or 355. If power is being supplied by the power cord 310 or 355, the switch 505 connects the AC power from the power cord 310 or 355 to the power line 465 and to the AC/DC converter 420. If power is not being supplied by the power cord 310 or 355, the switch connects the AC power from the DC/AC converter 500 to the power line 465 and to the AC/DC converter 420.

FIG. 9 illustrates a power unit 430b that can be incorporated in the drive unit 315 or 360 of FIG. 7, according to another embodiment of the invention. The power unit 430b receives AC power (e.g., 120 VAC) from the power cord 310 or 355. The AC power is connected to a first switch 530 and to an AC/DC converter 535. The AC/DC converter 535 converts the AC power to DC power and supplies the DC power to a second switch 540. DC power is supplied by one or more battery packs 305 or via cord 405 (from the battery station 400). The DC power is supplied to a DC/AC converter 545 which converts the DC power to AC power (e.g., 120 VAC) and supplies the AC power to the first switch 530. The DC power is also supplied to the second switch 540. The power unit 430b detects if power is being supplied by the power cord 310 or 355. If the power cord 310 or 355 is supplying AC power, the first switch 530 connects the AC power from the power cord 310 or 355 to the power line 465, and the second switch 540 connects the DC power from the AC/DC converter 535 to the power line 470. If the power cord 310 or 355 is not supplying AC power, the first switch 530 connects the AC power from the DC/AC converter 545 to the power line 465, and the second switch 540 connects the DC power from the battery pack 305 or battery station 400 to the power line 470.

FIG. 10 illustrates a power unit 430c that can be incorporated in the drive unit 315 or 360 of FIG. 7, according to another embodiment of the invention. In the embodiment shown, the motor 435 is a DC motor, and the motor 435, the light 445, and the control circuits 450 all operate using the same level of DC power (e.g., 24 vdc). In some embodiments, the light 445 does not operate, or operates for a shorter period, when power is being provided by the batteries (e.g., to save power). The power unit 430c receives AC power (e.g., 120 VAC) from the power cord 310 or 355. The AC power is connected to an AC/DC converter 560. The AC/DC converter 560 converts the AC power to DC power and supplies the DC power to a switch 565. DC power is also supplied to the switch 565 by one or more battery packs 305 or via cord 405 (from the battery station 400). The power unit 430c detects if power is being supplied by the power cord 310 or 355. If the power cord 310 or 355 is supplying AC power, the switch 565 connects the DC power from the AC/DC converter 560 to the line 465 and line 470. If the power cord 310 or 355 is not supplying AC power, the switch 565 connects the DC power from the battery packs 305 (or cord 405) to the line 465 and line 470.

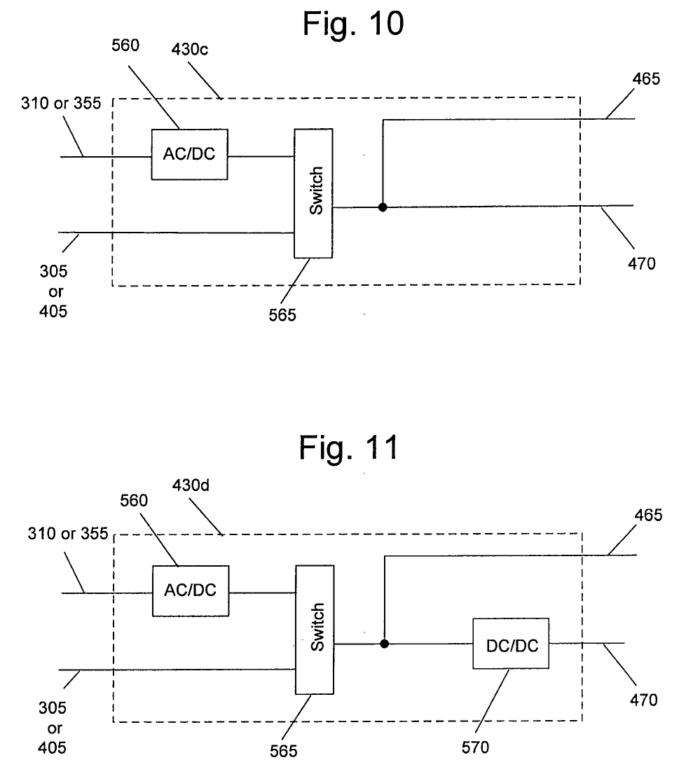

FIG. 11 illustrates a power unit 430d that can be incorporated in the drive unit 315 or 360 of FIG. 7, according to another embodiment of the invention. In the embodiment shown, the motor 435 is a DC motor. In some embodiments, the light 445 does not operate, or operates for a shorter period, when power is being provided by the batteries (e.g., to save power). The power unit 430d receives AC power (e.g., 120 VAC) from the power cord 310 or 355. The AC power is connected to an AC/DC converter 560. The AC/DC converter 560 converts the AC power to DC power and supplies the DC power to a switch 565. DC power is also supplied to the switch 565 by one or more battery packs 305 or via cord 405 (from the battery station 400). The power unit 430d detects if power is being supplied by the power cord 310 or 355. If the power cord 310 or 355 is supplying AC power, the first switch connects the DC power from the AC/DC converter 560 to the line 465 and also to a DC/DC converter 570. The DC/DC converter 570 converts the DC voltage (e.g., 24 vdc) to a level required by the control circuits 450 (e.g., 5 vdc). The DC/DC converter 570 then provides the new DC voltage to line 470. If the power cord 310 or 355 is not supplying AC power, the switch 565 connects the DC power from the battery packs 305 (or cord 405) to the line 465 and the DC/DC converter 570.

In some embodiments, where a DC motor 435 requires a higher voltage than the battery packs 305 can deliver, a DC/DC converter is used to step up the voltage delivered by the battery packs 305.

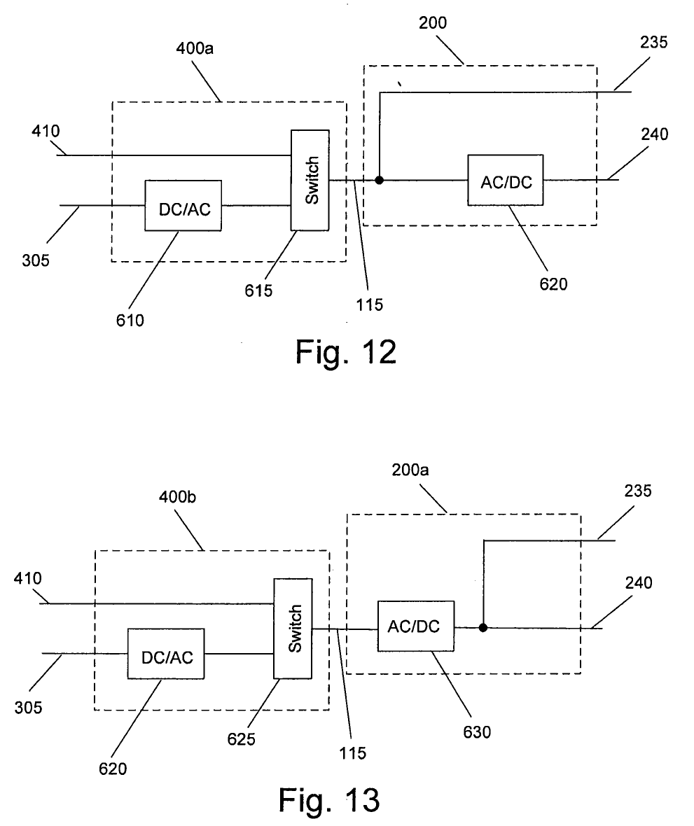

FIG. 12 illustrates an embodiment of the battery station 400a of FIG. 5, showing how the battery station 400a interfaces with a power unit 200 (not shown in FIG. 5) of the drive unit 120 of FIG. 5. AC power is supplied to the battery station 400a by the power cord 410. DC power is supplied by one or more battery packs 305. In some embodiments, the battery station 400a includes a battery charging circuit (not shown) for charging the battery pack 305. The DC power is supplied to a DC/AC converter 610 which converts the DC power to AC power (e.g., 120 VAC). The AC power from the power cord 410 and the AC power from the DC/AC converter 610 are both supplied to a switch 615. The battery station 400a determines if power is being supplied by the power cord 410. If power is being supplied by the power cord 410, the switch 615 connects the AC power from the power cord 410 to the power cord 115. If power is not being supplied by the power cord 410, the switch 615 connects the AC power from the DC/AC converter 610 to the power cord 115. The power cord 115 then supplies AC power to the power unit 200, which couples the AC power to the power line 235 and to the AC/DC converter 420, which converts the AC power into DC power on the power line 240.

FIG. 13 illustrates an embodiment in which the battery station 400a of FIG. 5 is replaced by a battery station 400b. In this embodiment, the drive unit 120 includes a power unit 200a and a DC motor 205. FIG. 13 illustrates how the battery station 400b interfaces with the power unit 200a. AC power is supplied to the battery station 400b by the power cord 410. DC power is supplied by one or more battery packs 305. In some embodiments, the battery station 400b includes a battery charging circuit (not shown) for charging the battery pack 305. The DC power is supplied to a DC/AC converter 620 which converts the DC power to AC power (e.g., 120 VAC). The AC power from the power cord 410 and the AC power from the DC/AC converter 620 are both supplied to a switch 625. The battery station 400b determines if power is being supplied by the power cord 410. If power is being supplied by the power cord 410, the switch 625 connects the AC power from the power cord 410 to the power cord 115. If power is not being supplied by the power cord 410, the switch 625 connects the AC power from the DC/AC converter 620 to the power cord 115. The power cord 115 then supplies AC power to the power unit 200a, which couples the AC power to an AC/DC converter 630 that converts the AC power into DC power which is supplied to lines 235 and 240. In some embodiments, a DC/DC converter steps down the power provided to line 240 or steps up the power to line 235.

The battery station 400a, as shown in FIG. 5, can also function as a battery back-up system for other AC powered devices, such as a computer. The battery station 400 can also provide power to DC powered devices, e.g., security lights, in the event of an AC power outage.

In some embodiments, a garage door opener is powered by removable battery packs exclusively (e.g., in locations where AC power is not available, such as a construction site or a boat house).

Embodiments of the invention can be used to operate other garage-related and non-garage-related enclosures besides garage doors, such as windows, doors, gates, fences, etc. Embodiments of the invention may also provide a signal that there is no AC power to the garage door opener by flashing lights, sounding an alarm, etc. In some embodiments, the battery packs can be used to power other devices such as lights, property alarm systems, intercoms, electronic locks, etc. Embodiments of the invention also contemplate other types of secondary power sources such as automobile batteries, solar power, non-removable batteries, etc.

The embodiments described herein are for illustration of the invention. The invention also contemplates other methods and circuits for powering a garage door opener using a removable battery and converting between AC power and DC power. In addition, cords can be replaced by other suitable conductive interfaces including adapters, plugs, inductance couplings, etc.

Thus, the invention provides, among other things, a garage door opener having a secondary power source including a removable battery. Various features and advantages of the invention are set forth in the following claims.

What is claimed is:

1. An electric garage door opener comprising:
a drive unit configured to be coupled to an external AC power source and to a removable battery pack that provides DC power, the drive unit including
a power unit,
a motor coupled to the power unit, and
a drive mechanism coupled to the motor,
an opening mechanism coupled to the drive mechanism and configured to open and close a garage door;
wherein the power unit uses the DC power to operate the garage door opener when AC power is not available.

2. The garage door opener of claim 1, further comprising a power cord configured to couple the power unit to the external AC power source.

3. The garage door opener of claim 1, wherein the motor is a DC motor.

4. The garage door opener of claim 3, wherein the power unit includes an AC/DC converter.

5. The garage door opener of claim 1, further comprising a receptacle configured to receive the battery pack and electrically connect the battery pack to the power unit.

6. The garage door opener of claim 1, wherein the power unit is electrically coupled to a battery station positioned remotely from the drive unit.

7. The garage door opener of claim 6, wherein the battery station provides DC power to the power unit.

8. The garage door opener of claim 6, wherein the battery station provides AC power to the power unit.

9. The garage door opener of claim 8, wherein the battery station includes a power cord for receiving AC power, the battery station providing AC power from the power cord to the power unit when AC power is available.

10. The garage door opener of claim 9, wherein the battery station includes a DC/AC converter configured to convert DC power from the battery pack into AC power, the battery station providing the AC power from the DC/AC converter to the power unit when AC power from the power cord is not available.

11. The garage door opener of claim 6, wherein the battery station includes a receptacle configured to receive a battery pack.

12. The garage door opener of claim 1, further comprising a charging circuit configured to charge the battery pack when the AC power is available.

13. A method of powering an electric garage door opener, the method comprising:
supplying AC power to a power unit of the garage door opener;
supplying DC power from a battery pack to the power unit, the battery pack removably coupled to the power unit;
operating the garage door opener with the AC power; and
operating the garage door opener with the DC power when the AC power is not available.

14. The method of claim 13, wherein the battery pack is coupled to the power unit through a battery station remote from a drive unit of the garage door opener, the battery pack releasably attached to the battery station.

15. The method of claim 13, further comprising charging the battery pack when the AC power is available.

16. The method of claim 13, further comprising powering a DC motor for opening and closing a garage door.

17. The method of claim 16, further comprising converting the AC power to DC power to power the motor.

18. A power system for powering an electric garage door opener, the power system comprising:
a first power cord;
a housing including
a receptacle configured to releasably receive a battery pack, and
a power unit coupled to the first power cord and the receptacle; and
a socket on the housing coupled to the power unit and configured to supply AC power to a second power cord coupled to a garage door opener;
wherein the power unit receives AC power from the power cord and DC power from the battery pack, the power unit providing the AC power from the power cord to the socket and using the DC power to generate AC power at the socket when AC power is unavailable from the power cord.

19. The power system of claim 18, further comprising a charging circuit configured to charge the battery pack using the AC power.

20. The power system of claim 19, further comprising a second receptacle configured to releasably receive a second battery pack.

21. The power system of claim 20, wherein the battery pack and the second battery pack are at least one of different voltages and different chemistries.
